(19) United States
(12) Patent Application Publication
(10) Pub. No.: US 2015/0323973 A1
(43) Pub. Date: Nov. 12, 2015

(54) METHOD FOR CONTROLLING OUTPUT OF A POWER SUPPLY UNIT TO SUPPLY POWER TO MULTIPLE PROCESSORS

(71) Applicant: LENOVO (SINGAPORE) PTE. LTD., SINGAPORE (SG)

(72) Inventor: SHIGEFUMI ODAOHHARA, Kanagawa-ken (JP)

(21) Appl. No.: 14/705,657

(22) Filed: May 6, 2015

(30) Foreign Application Priority Data
May 9, 2014 (JP) 2014-098070

(51) Int. Cl. G06F 1/32

(52) U.S. Cl. CPC G06F 1/324; G06F 1/3206; G06F 1/3296

(57) ABSTRACT

A method for controlling an output of a power supply unit (PSU) in order to prevent a shutdown of the PSU to supply power to a group of processors (CPUs) is disclosed. A PSU supplies power to a multicore CPU. An input current flowing into multiple CPU cores includes a pulse current. When the pulse current of each of CPU cores is superposed on an output current of the PSU, a protection device is operated to perform a shutdown. A clock control determination unit compares the output current and a reference signal and thereby outputs a control signal. A group of peak detection units detects a peak value of the pulse current. A control unit selects a processor targeted for clock control, based on the peak value and outputs a control signal for reducing a clock frequency to the selected processor while receiving the control signal.

### PRIORITY CLAIM

The present application claims benefit of priority under 35 U.S.C. §§120, 365 to the previously filed Japanese Patent Application No. JP2014-098070 with a priority date of May 9, 2014, which is incorporated by reference herein.

### BACKGROUND OF THE INVENTION

1. Technical Field

The present invention relates to power supply units in general, and particularly to a method for controlling an output of a power supply unit to supply power to a group of processors.

2. Description of Related Art

An information processing device like a server has been equipped with a multicore CPU equipped with multiple central processing units (CPUs) or a multicore CPU in which multiple CPU cores are mounted to a single package. The CPUs are operated while sharing tasks in various algorithms. For the present disclosure, when the term “CPU core” is used, an independent CPU having multicore CPU is also assumed to be included therein.

Within a general power supply system designed for multicore CPUs, multiple DC/DC converters branched from a single power supply unit (PSU) supply power to their corresponding CPU cores. The present disclosure provides a method for controlling an output of a PSU to supply power to a group of processors.

### SUMMARY OF THE INVENTION

In accordance with a preferred embodiment of the present invention, a power supply system includes a power supply unit, a clock control determination unit, a peak detection unit, a control object selecting part and a control signal output part. The power supply unit supplies power to a group of processors. The clock control determination unit compares an output current of the power supply unit to a reference signal in order to determine whether or not a first control signal should be sent. The peak detection unit detects and outputs a peak value of an input current flowing into each of the processors. The control object selecting unit selects at least one of the processors based on the peak value, and then outputs a second control signal corresponding to the selected processor. The control signal output unit outputs a third control signal to reduce a clock frequency to the selected processor when the control signal output unit receives the first control signal and the second control signal.

All features and advantages of the present disclosure will become apparent in the following detailed written description.

### BRIEF DESCRIPTION OF THE DRAWINGS

The disclosure itself, as well as a preferred mode of use, further objects, and advantages thereof, will best be understood by reference to the following detailed description of an illustrative embodiment when read in conjunction with the accompanying drawings, wherein:

FIG. 1 is a block diagram of a power supply system for a server;

FIG. 2 is a diagram depicting the waveforms of an input current of a CPU and an output current of a PSU;

FIG. 3 is a block diagram of a peak detection unit;

FIG. 4 is a block diagram of a control unit;

FIG. 5 is a diagram depicting a first control method for outputting a control signal;

FIG. 6 is a flowchart describing an operation procedure of the first control method;

FIG. 7 is a diagram depicting a second control method for outputting a control signal;

FIG. 8 is a flowchart describing an operation procedure of the second control method; and

FIG. 9 is a diagram depicting the waveform of a current that flows into a CPU core executing an overclock.

### DETAILED DESCRIPTION OF A PREFERRED EMBODIMENT

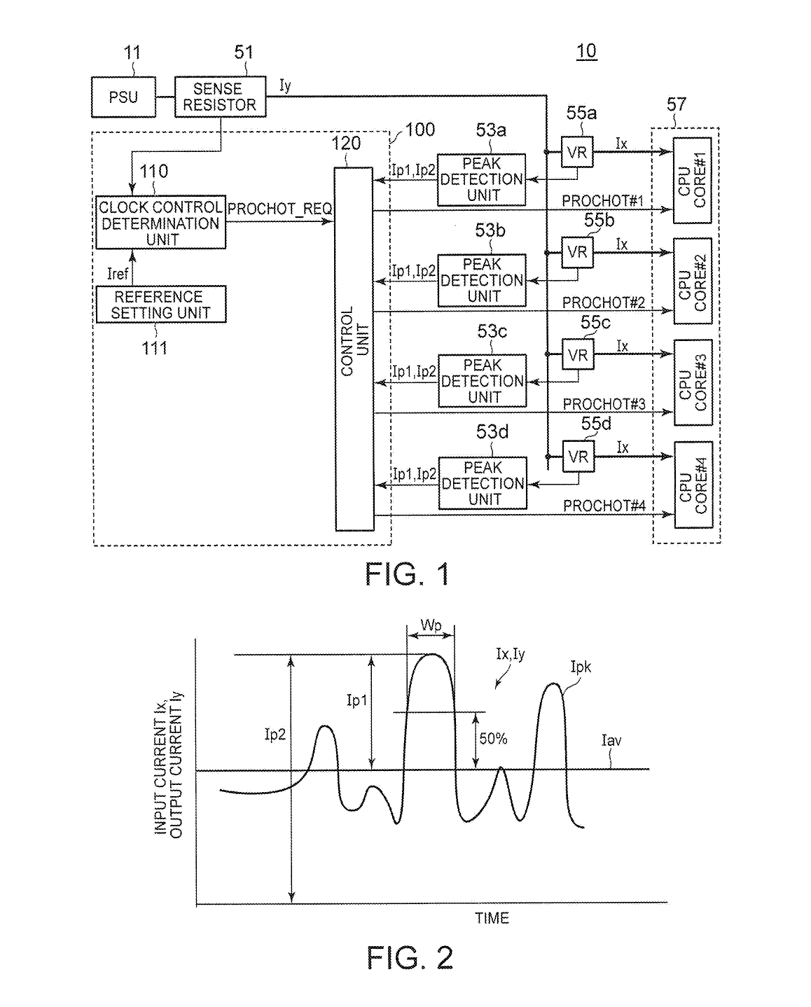

FIG. 1 is a block diagram of a power supply system 10 mounted on a server. The power supply system 10 can also be mounted on an information processing device other than the server. A power supply unit (PSU) 11 is configured by a switching regulator which converts a commercial power supply to a predetermined DC voltage. A sense resistor 51 has both ends connected to a clock control determination unit 110 of a Baseboard Management Controller (BMC) 100 and outputs an output current Iy flowing into the PSU 11 as a voltage signal. The PSU 11 is equipped with a protection device for performing overload protection. The protection device shuts down the PSU 11 when the output current Iy of the PSU 11 continuously exceeds an operating current Ih for a predetermined time or more.

A multicore CPU 57 is preferably connected to the PSU 11 as a load via voltage regulators (VR) 55a through 55d, respectively. The multicore CPU 57 includes four CPU cores#1 through #4 by way of example, but there is no limit to the number of CPU cores in the applications of the present invention. Further, the PSU 11 may be connected with a processor other than the multicore CPU or a load other than the processor. In the present embodiment, the rated currents of the CPU core #1 through core #4 will be described as being equal to each other, but they may be different from each other.

The VR 55a-VR 55d convert the output voltage of the PSU 11 to stable DC voltages and supply power to the CPU cores#1 through #4. The multicore CPU 57 can be configured as Xeon® Processor manufactured by Intel as an example. When a control signal (PROCHOT#) is asserted to an external terminal of each of the CPU cores#1 through #4, each CPU core lowers its clock frequency and lowers its operating voltage independent of each other in order to reduce power consumption. Thus, a reduction in the power consumption by using the external terminal of each CPU core is referred to as clock control.

Incidentally, the present invention can be applied to a multicore CPU of such a type that a signal other than the control signal (PROCHOT#) is sent from each external terminal to enable the clock control. In a preferred embodiment, the multicore CPU 57 supports an operation by an overclock like turbo boost. However, a processor to which the present invention is applicable needs not support the turbo boost if it is of a type that it automatically changes the clock frequency according to the load. An input current Ix flows into each of the CPU core #1 through core #4.

FIG. 2 is a diagram depicting the waveform of the input current Ix flowing into VR 55a of the CPU core #1 on behalf of VR 55a-VR 55d, and the waveform of the output current Iy of the PSU 11. The input current Ix is a pulsating current in which a pulse current Ipk is superposed on a base current. A pulse current Ipk in which a pulse width Wp is less than or equal to 10 ms will be described by way of illustration in the present embodiment although it does not limit the present invention. The pulse width Wp can be specified at a position where it is 49% of a peak value Ip1 to be described later.

The magnitude of the pulsating current can be specified by an average value Iav of the input current Ix and a peak value Ip2 of the pulsating current at a given time. In the present embodiment, the peak value Ip1 corresponding to the difference between the peak value Ip2 of the pulsating current and the average value Iav is assumed to be the peak value Ip1 of the pulse current, and a waveform portion (portion exceeding the average value Iav) forming the peak value Ip1 is assumed to be the pulse current Ipk. The pulsating current in which the pulse current Ipk changed with a timing corresponding to the load of each CPU core flows becomes values different each time the average value Iav and the peak values Ip1 and Ip2 evaluate the pulsating current. Pulsating currents each including a similar pulse current Ipk flow even into other CPU core 57b through core 57d.

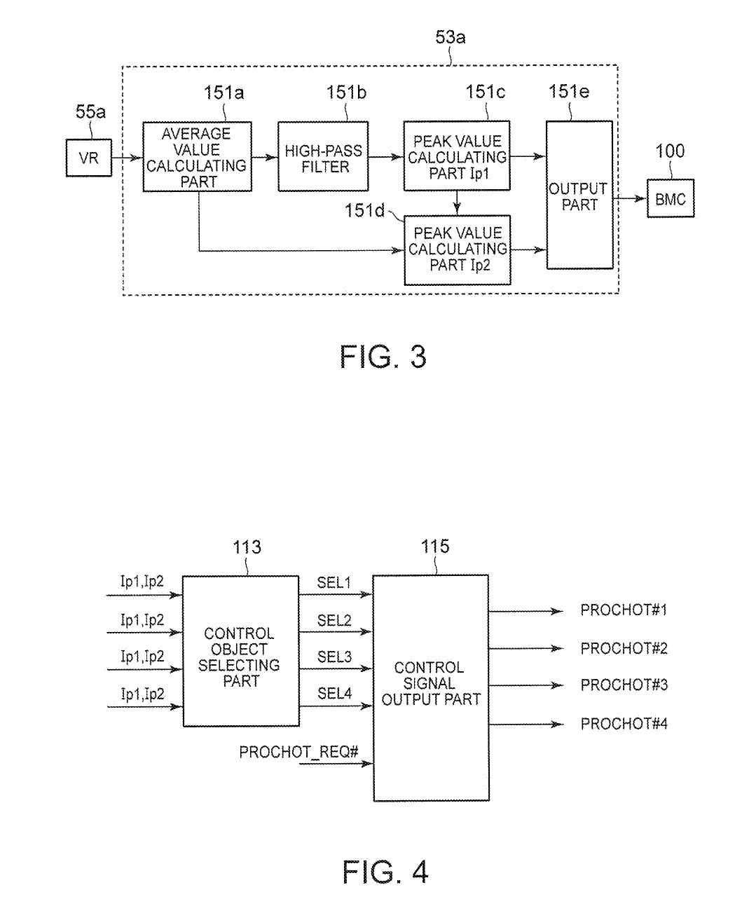

Further, the output current Iy of the PSU 11 becomes a pulsating current obtained by combining the input currents Ix flowing into the respective VR 55a through 55d of the CPU core #1 through core #4. The peak values Ip1 and Ip2 and the average value Iav can be specified in a manner similar to the input current Ix. The peak detection units 53a through 53d respectively detect the peak values Ip1 and Ip2 of the input currents Ix flowing through the VR 55a-VR 55d. The peak detection units 53a through 53d can be incorporated into their corresponding VR 55a-VR 55d. FIG. 3 is a functional block diagram for describing the configuration of the peak detection unit 53a. Other peak detection units 53b through 53d can also be configured in like manner.

The peak detection unit 53a is configured with hardware and includes an average value calculating part 151a, a high-pass filter 151b, peak value calculating parts 151c and 151d, and an output part 151e. The average value calculating part 151a calculates the average value Iav of the input current Ix flowing into each CPU core. In one example, the high-pass filter 151b allows only a current of frequency of 100 KHz or more included in the input current Ix to pass at a cutoff frequency of 100 KHz (period 10 μs).

The peak value calculating part 151c includes a differentiation circuit and an integration circuit or the like and calculates the peak value Ip1 of the pulse current from the input current Ix having passed through the high-pass filter 151b. The peak value calculating part 151d adds up the average value Iav and the peak Ip1 of the pulse current Ipk to calculate the peak value Ip2 of the pulsating current. The output part 151e outputs the peak value Ip1 of the pulse current and the peak value Ip2 of the pulsating current or either one of them by setting.

Referring back to FIG. 1, BMC 100 is a microcomputer including a processor, a RAM, a firmware ROM and a hardware logic circuit or the like and clock-controls the selected CPU core, based on the output current Iy flowing into the PSU 11 and the peak values Ip1 and Ip2 detected by the peak detection units 53a through 53d respectively. A reference signal setting unit 111 sends a reference signal Iref of a triangular wave having a constant value or a predetermined period to the clock control determination unit 110 as a voltage signal corresponding to the output current Iy.

The clock control determination unit 110 includes a comparator. When the reference signal Iref set by the reference signal setting unit 111 and the output current Iy are compared with each other and the output current Iy exceeds the reference signal Iref, the comparator outputs a request signal (PROCHOT_REQ#) to the control unit 120. In one example of a control method to be described later, the clock control determination unit 110 is capable of generating a sampling clock of a period of 100 μs by way of example to obtain a timing for comparing the reference signal Iref and the output current Iy.

The control unit 120 includes a control object selecting part 113 and a control signal output part 115 as illustrated in FIG. 4. The control unit 120 can be implemented as a function based on cooperation of the processor and RAM or the like executing firmware of the BMC 100. Further, in another example, the control unit 120 can also be realized only by the BMC 100 or a hardware logic circuit independent of the BMC 100.

The control object selecting part 113 receives the peak value Ip1 of the pulse current or the peak value Ip2 of the pulsating current from each of the peak detection units 53a through 53d and selects the CPU core targeted for clock control with an algorithm to be described later. The control object selecting part 113 outputs a selection signal (SEL) corresponding to the CPU core selected by the control signal output part 115. Incidentally, in the present invention, since the control object selecting part 113 can select the CPU core targeted for the clock control even based on both of the peak value Ip1 and the peak value Ip2, the peak value Ip1 and the peak value Ip2 are assumed to be collectively called an peak value Ip subsequently unless both need to be distinguished from each other.

The control object selecting part 113 selects one or more CPU cores as the objects to be clock-controlled simultaneously based on the peak value Ip and outputs their corresponding selection signals (SEL). The control object selecting part 113 is capable of selecting as the objects to be clock-controlled, a group of CPU cores in each of which the peak value exceeds a predetermined threshold, a CPU core maximum in the peak value, and a predetermined number of CPU cores starting from the large peak value. The control object selecting part 113 is capable of outputting the selection signals (SEL) corresponding to the selected CPU cores each time the order of the magnitude of the peak value Ip changes. The control signal output part 115 determines the establishment of a clock control condition, based on the request signal (PROCHOT_REQ#) and the selection signals (SEL) with the timing of the sampling clock. The period of the sampling clock can be taken to be 100 μs as an example.

There is a case when any selection signal (SEL) is not outputted where the control object selecting part 113 compares the threshold and the peak value and selects the object to be clock-controlled. At this time, the control signal output part 115 determines that the clock control condition has been established when the control signal output part 115 has received the request signal (PROCHOT_REQ#) and any selection signal (SEL) simultaneously. When the clock control condition is established, the control signal output part 115 outputs a control signal (PROCHOT#) to the CPU core specified by the selection signal (SEL).

The control signal output part 115 is capable of stopping the once-outputted control signal (PROCHOT#) after a constant hold time of 10 ms or so as one example and thereby releasing the clock control. In another example, the control signal output part 115 is capable of outputting and stopping the control signal (PROCHOT#) with assert and negate timings of the request signal (PROCHOT_REQ#). If the control signal output part 115 determines the clock control condition to have been established continuously after the release of the clock control, the control signal output part 115 outputs a control signal (PROCHOT#).

### I. A First Control Method

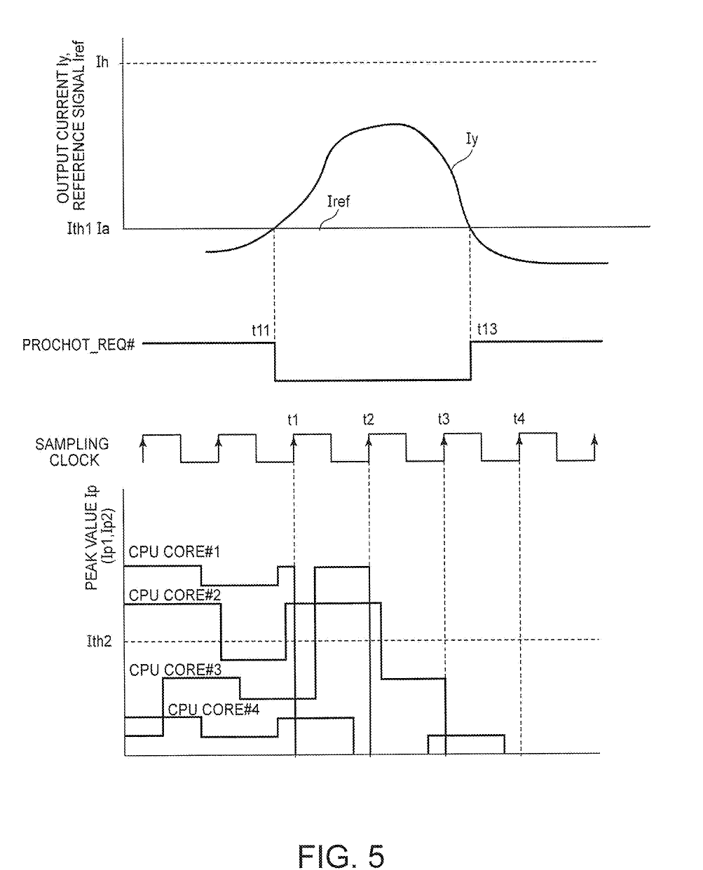

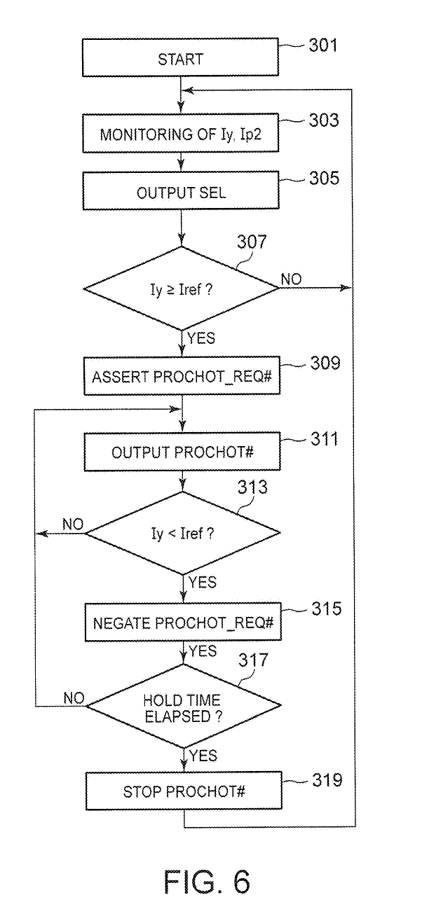

FIG. 5 is a diagram depicting a first control method in which a control signal (PROCHOT#) is outputted using a reference signal Iref of a constant value. FIG. 6 is a flowchart describing an operation procedure of the first control method. In a block 301, the reference signal setting unit 111 outputs a reference signal Iref of a constant value Ith1 equivalent to the rated current Ia of the PSU 11. Although the constant value Ith1 may be a value larger than the rated current Ia depending on the type of PSU, the present invention can be applied even to such a PSU.

The operating current Ih the protection device is set to 130% of the rated current Ia as an example. The protection device shuts down the PSU 11 when the output current Iy exceeds the operating current Ih for 5 ms as an example. The operating current Ih is principally determined by the thermal capacity of the PSU 11. In the related art control method, since the control signals (PROCHOT#) are outputted to all CPU core #1 through core #4 to perform the clock control when the output current Iy exceeds the rated current Ia only for a predetermined time, the performance has been reduced than as required. Alternatively, there was a need to adopt a PSU having an excessive rated capacity to the rated capacity of the multicore CPU 57 in order to avoid the execution of clock control.

In a block 303, the clock control determination unit 110 compares the output current Iy and the reference signal Iref. The control object selecting part 113 continuously receives the peak values Ip from the peak detection units 53a-53d and compares correlations in the magnitudes of the respective peak values. Alternatively, the control object selecting part 113 compares each peak value Ip and a threshold Ith2. In a block 305, the control object selecting part 113 selects, as one example, a CPU core maximum in peak value as an object to be clock-controlled and outputs its corresponding selection signal (SEL). When the clock control determination unit 110 determines in a block 307 that the output current Iy is larger than the reference signal Iref, the clock control determination unit 110 asserts a request signal (PROCHOT_REQ#) in a block 309. FIG. 5 shows the manner in which the clock control determination unit 110 asserts the request signal (PROCHOT_REQ#) at a time t11.

The control signal output part 115 determines the establishment of a clock control condition from the request signal (PROCHOT_REQ#) with the timing of the sampling clock illustrated in FIG. 5. The frequency of the sampling clock can be taken to be 10 KHz (period 100 μs) as an example. Since the request signal (PROCHOT_REQ#) is negated before the time t11, the control signal output part 115 determines that the clock control condition is not established, and does not output the control signal (PROCHOT#). The clock control condition has been established at a time t1 that arrives in the first time after the time t11.

Since the peak value Ip of the CPU core #1 becomes the largest at this time, the control object selecting part 113 outputs a selection signal (SEL1) corresponding to the CPU core #1 in the block 305. In a block 311, the control signal output part 115 outputs a control signal (PROCHOT#1) to the CPU core #1 corresponding to the selection signal (SEL1). As a result, the input current Ix of the clock-controlled CPU core #1 and the output current Iy of the PSU 11 are decreased. The control signal output part 115 sets a constant hold time like 10 ms as one example to each control signal (PROCHOT#).

When the clock control determination unit 110 determines in a block 313 that the output current Iy is still larger than the reference signal Iref due to the assertion of the request signal (PROCHOT_REQ#) at a time t2 and subsequently, the clock control determination unit 110 returns to the block 311. The control object selecting part 113 specifies a CPU core maximum in the peak value Ip at the timing of the rising edge of the sampling clock at the time t2 and outputs a selection signal (SEL). Since the peak value Ip of the CPU core #3 is the largest in the example of FIG. 5, the control signal output part 115 outputs a control signal (PROCHOT#3) to the CPU core #3 corresponding to the control signal (SEL3) in the block 311. As a result, the CPU core #3 is clock-controlled to further decrease the output current Iy. Since the hold time of the control signal (PROCHOT#1) does not elapse at this time, the clock control of the CPU core #1 is continued.

Similarly, the control signal output part 115 outputs a control signal (PROCHOT#2) to the CPU core #2 at the time t3. Since the output current Iy is lowered than the reference current Iref in the block 313 at a time t13, the clock control determination unit 110 negates the request signal (PROCHOT_REQ#) in a block 315. As a result, the clock control condition is released. The control signal output part 115 having recognized in a block 317 that the request signal (PROCHOT_REQ#) has been negated monitors the hold times of the CPU cores#1, #2 and #3 having already outputted the control signals (PROCHOT#) and stops in a block 319, the control signal (PROCHOT#) to each CPU core in which the hold time has elapsed.

Since the hold time is set to a value approximately close to the pulse width Wp of the pulse current Ipk assumed to be in the input current Ix of each CPU core, there is a high possibility of not causing an increase in the output current Iy even if the clock control of the CPU core in which the hold time has elapsed is released. As a result, the clock frequency is returned to the rated value in the CPU core in which the hold time has elapsed. When the output current Iy rises due to the release of the clock control, this is processed by the procedure from and after the block 303.

Although a description has so far been made about the example in which in the block 305, the control object selecting part 113 clock-controls the CPU core maximum in the peak value Ip with the timing of the sampling clock until the condition (Iy<Iref) of the block 313 is established, the control object selecting part 113 may select plural CPU cores of two to three selected in order of decreasing the peak value at a time as the objects to be clock-controlled where the number of the CPU cores is large, and output the selection signals (SEL). Further, when a predetermined threshold Ith2 is set to the peak value Ip and the request signal (PROCHOT_REQ#) is asserted, the control signals (PROCHOT#) may be outputted to all CPU cores being beyond the threshold Ith2 with the timing of the sampling clock.

In this case, the clock control condition is established when the control signal output part 115 has received the request signal (PROCHOT_REQ#) and the selection signal (SEL) simultaneously. For example, since the CPU cores#1 and #2 are beyond the threshold Ith2 at the time t1, the control signal output part 115 outputs the control signals (PROCHOT#1 and #2). If only the CPU core #3 is beyond the threshold Ith2 at the time t2, the control signal output part 115 further outputs the control signal (PROCHOT#3). If both of the CPU cores#3 and #4 are smaller than the threshold Ith2 in peak value at the time t3, no additional clock control is done at that time.

The control object selecting part 113 is capable of adopting both of the peak value Ip1 of the pulse current and the peak value Ip2 of the pulsating current as the peak values Ip for selecting the CPU cores targeted for the clock control. If the control object selecting part 113 selects the CPU core taken to be an object to be clock-controlled, based on the peak value Ip1 of the pulse current, it is possible to select the CPU core through which the pulse current Ipk large in peak value Ip1 and small in average value Iav flows. In this case, since the CPU core small in average current Iav is low in processing amount, it is possible to prevent a shutdown of the PSU 11 while preventing a decrease in performance of the whole multicore CPU 57.

Further, if the control object selecting part 113 selects the CPU core to be clock-controlled, based on the peak value Ip2 of the pulsating current, the CPU core highest in effect in reducing the peak value Ip of the output current Iy of the PSU 11 is selected. Although there is a case in which the processing amount of the CPU core to be selected is large in this case, it is possible to more reliably prevent a shutdown of the PSU 11 because the CPU core capable of most effectively reducing the peak value of the output current Iy is selected.

The control object selecting part 113 may select the peak values Ip1 and Ip2 used for the selection of the object to be clock-controlled, according to the magnitude of the average value Iav of the output current Iy. For example, when the average Iav of the output current Iy is approaching the threshold Ith1, the protection device has a high possibility of being operated when a large pulse current suddenly overlaps with the output current Iy. Therefore, it is possible to perform the most effective clock control on the CPU core using the peak value Ip2 to prevent the shutdown. On the other hand, since the possibility of the shutdown is low when the average value Iav of the output current Iy is sufficiently smaller than the threshold Ith1, the peak value Ip1 is adopted with the suppression of the decrease in the performance taken in priority to thereby enable clock control.

Although a description has been made about the example in which the control signal (PROCHOT#) is held for 10 ms in the block 311, it is possible to output and stop each control signal (PROCHOT#) based on the state of the request signal (PROCHOT_REQ#) with the timing of the sampling clock without holding the control signal (PROCHOT#). As an example, the clock control determination unit 110 compares the reference signal Iref and the output current Iy with a timing of a sampling clock of 100 μs and asserts the request signal (PROCHOT_REQ#) only for a period during which the output current Iy is large.

When the request signal (PROCHOT_REQ#) is asserted, the control signal output part 115 outputs a control signal (PROCHOT#) to a CPU core corresponding to the selection signal (SEL) received from the control object selecting part 113. When the request signal (PROCHOT_REQ#) is negated, the control signal output part 115 stops the control signal (PROCHOT#). The control signal output part 115 may carry out the comparison between the reference signal Iref and the output current Iy with the timing of the sampling clock.

At this time, the control object selecting part 113 is capable of outputting selection signals (SEL) corresponding to all CPU cores in which the peak value Ip has exceeded the predetermined threshold Ith2. Also, the control object selecting part 113 is capable of outputting selection signals (SEL) corresponding to a predetermined number of CPU cores selected in order of decreasing the peak values Ip with the timing of the sampling clock. Further, the control object selecting part 113 is capable of outputting a selection signal (SEL) corresponding to each CPU core always maximum in peak value Ip.

In this case, until the output current Iy becomes smaller than the reference signal Iref and the clock control condition is released in the block 313, only the CPU cores maximum in peak value can be clock-controlled in order with the timing of the sampling clock. For example, when the request signal (PROCHOT_REQ#) is negated at the time t2 as a result of the clock control on the CPU core #1 largest in the peak value Ip at the time t1 of FIG. 5, the control signal (PROCHOT#1) is stopped. While maintaining the control signal (PROCHOT#1) when the request signal (PROCHOT_REQ#) is asserted even at the time t2, the CPU core #3 largest in the peak value Ip is clock-controlled with the timing of the time t2.

Then, when the request signal (PROCHOT_REQ#) is negated with the timing of the time t3, the control signals (PROCHOT#) for the CPU cores#1 and #3 clock-controlled at that time are stopped. Since it is possible for this control method to execute and stop the clock control with the timing of the sampling clock, it is possible to prevent a shutdown while performing fine control corresponding to the magnitude of the output current Iy and minimizing a decrease in performance.

### II. A Second Control Method

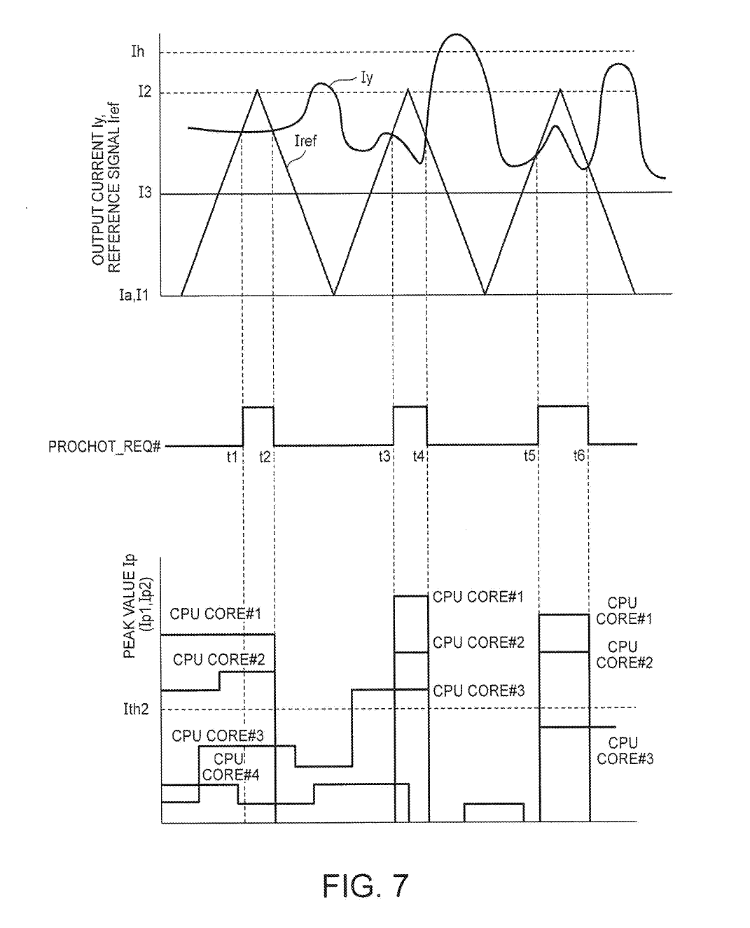

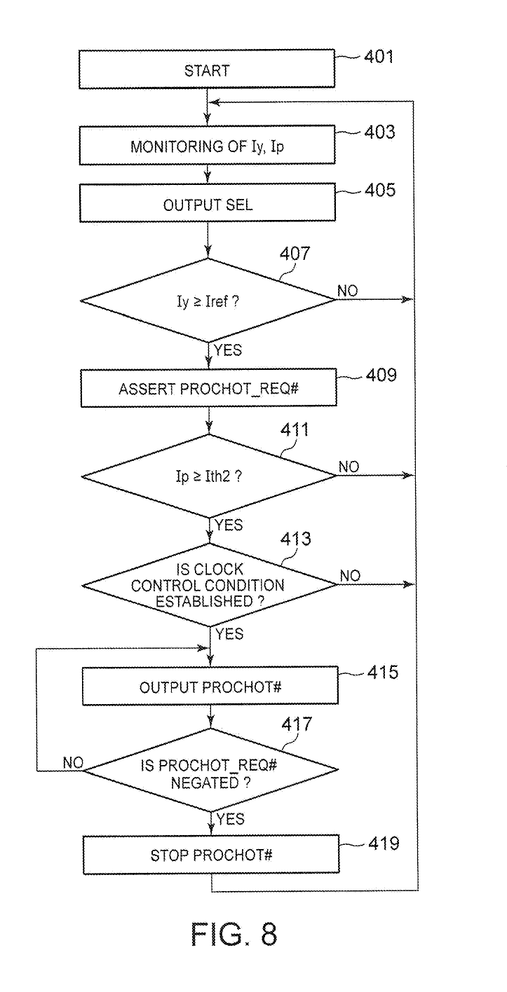

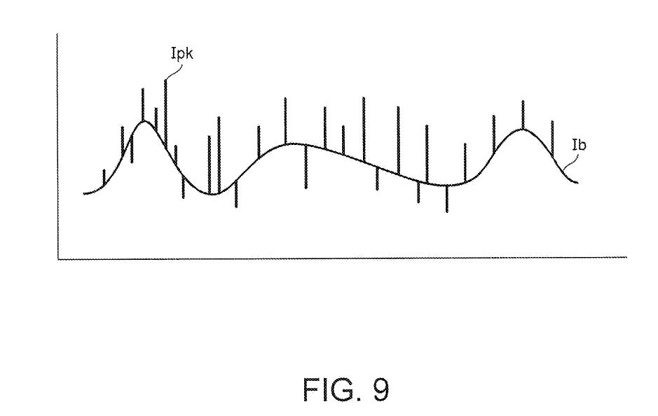

FIG. 7 is a diagram depicting a second control method in which a control signal (PROCHOT#) is outputted and stopped by a request signal (PROCHOT_REQ#) generated using a reference signal Iref of a triangular wave. FIG. 8 is a flowchart describing an operation procedure of the second control method. In a block 401, the reference signal setting unit 111 outputs a triangular wave reference signal Iref having a frequency of 10 KHz (period 100 μs) and a center value of I3 by way of example.

As one example, a peak value I1 of the bottom of the reference signal Iref is made to coincide with the rated current Ia of the PSU 11, a peak value I2 of the top thereof is set to 125%, and an operating current Ih of the protection device is set to 130% of the rated current. A difference between the operating current Ih and the peak value I2 of the top is a margin for preventing a shutdown. The control object selecting part 113 sets a threshold Ith2 to the peak value Ip of the input current Ix of each CPU core. When the rated currents of the CPU cores are different from each other, the control object selecting part 113 is capable of setting thresholds Ith2 of different values according to the rated currents.

In a block 403, the clock control determination unit 110 continuously compares the reference signal Iref and an output current Iy. The control object selecting part 113 compares the peak values Ip and thresholds Ith2 continuously received from the peak detection units 53a through 53d. The control object selecting part 113 selects a CPU core having a peak value which exceeds the threshold Ith2 as an object to be clock-controlled in a block 405 and outputs its corresponding selection signal (SEL). In a block 407, the clock control determination unit 110 determines that the output current Iy is larger than the reference signal Iref at a time t2 and asserts a request signal (PROCHOT_REQ#) in a block 409. In a block 411, the control object selecting part 113 proceeds to a block 413 where it receives the selection signal (SEL) corresponding to the CPU core in which the peak value Ip exceeds the threshold Ith2.

Since the peak values Ip of the CPU cores#1 and #2 exceed the threshold Ith2 at the time t2 in the example of FIG. 7, these CPU cores are selected as objects to be clock-controlled. The control object selecting part 113 outputs control signals (SEL1 and SEL2) corresponding to the CPU cores#1 and #2. In a block 413, the control signal output part 115 determines based on the assertion of the request signal (PROCHOT_REQ#) and the output of the control signals (SEL1 and SEL2) that the clock control condition has been established, and outputs control signals (PROCHOT#1 and #2) to the CPU cores#1 and #2 in a block 415. As a result, the CPU cores#1 and #2 are clock-controlled to reduce the input current Ix and the output current Iy.

In a block 417, the control signal output part 115 outputs each control signal (PROCHOT#) until the request signal (PROCHOT_REQ#) is negated. When the request signal (PROCHOT_REQ#) is negated at a time t3, the clock control condition is released and hence in a block 419, the control signal output part 115 stops the control signals (PROCHOT#1 and #2) which have been outputted up to that time. As a result, the CPU cores#1 and #2 are released from being clock-controlled and the output current Iy is also increased.

Since the peak values Ip of the CPU cores#1, #2 and #3 exceed the threshold Ith2 when the request signal (PROCHOT_REQ#) is asserted at a time t4, the control signal output part 115 outputs the control signals (PROCHOT#1, #2 and #3) to the CPU cores#1, #2 and #3. Likewise, at a time t5, the request signal (PROCHOT_REQ#) is negated and the CPU core #1, core #2 and core #3 are released from being clock-controlled. Even if the output current Iy temporarily exceeds the operating current Ih between the times t4 and t5, the protection device is not operated unless the output current Iy exceed it for 5 ms. The output current Iy can also be controlled so as not to exceed the operating current Ih by increasing a margin of the reference signal Iref to the operating current Ih.

Although a description has been made in the block 419 about the example in which all control signals (PROCHOT#) which have been outputted up to that time are stopped, the CPU cores that stop the control signals (PROCHOT#) may be selected according to the average value Iav of the output current Iy. For example, it is possible to select the CPU core smallest in the peak value Ip where the average value Iav of the output current Iy is larger than the rated current Ia and select all CPU cores when the average value Iav becomes smaller than the rated current. As a result, it is possible to prioritize the prevention of a shutdown when the output current is large, and prioritize suppression of a decrease in performance when the average value Iav is small.

Now compare where the reference signal Iref is set to a triangular wave signal and where it is set to the constant value signal as illustrated in FIG. 5. In the case of the constant value signal, the request signal (PROCHOT_REQ#) is always asserted when the output current Iy exceeds the constant value Ith1, so that the selected CPU core is clock-controlled. In the case of the triangular wave signal, the clock control is started when the output current Iy exceeds the peak value I1 (rated current Ia) of the bottom of the triangular wave signal. However, since there also exists a time zone not subjected to the clock control even if the output current Iy exceeds the peak value I1, it is possible to suppress the decrease in performance rather than the adoption of the constant value signal. Further, as the output current Iy becomes larger, the time when the request signal (PROCHOT_REQ#) is asserted becomes gradually long, and the time taken for the clock control also becomes long. It is therefore possible to reliably prevent a shutdown.

As has been described, the present disclosure provides an improved method for controlling an output of a power supply unit to supply power to a group of processors.

While the disclosure has been particularly shown and described with reference to a preferred embodiment, it will be understood by those skilled in the art that various changes in form and detail may be made therein without departing from the spirit and scope of the disclosure.

What is claimed is:

1. A method comprising:
determining whether or not an output current of a power supply unit has exceeded a predetermined value, wherein said power supply unit supplies power to a plurality of processors; and
in response to said output current has exceeded said predetermined value,
measuring a peak value of an input current flowing into each of said plurality of processors;
selecting one of said processors based on said measured peak value; and
outputting a control signal to reduce a clock frequency to said selected processor.

2. The method of claim 1, wherein said peak value is a peak value of a pulse current superposed on a base current.

3. The method of claim 2, wherein said pulse current is generated by an overclock control in which a clock frequency of said processor temporarily rises, and wherein a pulse width of said pulse current is less than 10 ms.

4. The method of claim 1, wherein said peak value is a total value of an average value of said input current and a peak value of a pulse current superposed on said base current.

5. The method of claim 1, wherein said selecting further includes selecting all processors in each of which said peak value exceeds a second predetermined value, from among said plurality of processors.

6. The method of claim 1, wherein said selecting further includes selecting a predetermined number of processors in the order of magnitude of said peak value among said plurality of processors.

7. The method of claim 1, wherein said selecting further includes selecting, according to the magnitude of said average value of said input current, either said peak value of said pulse current superposed on said base current or said total value of said average value of said input current and said peak value of said pulse current.

8. The method of claim 1, wherein said method further includes stopping said control signal to a corresponding one of said processors when said control signal being outputted exceeds a third predetermined value.

9. A method comprising:
determining whether an output current of a power supply unit is larger than a reference signal, wherein said power supply unit supplies power to a plurality of processors;
in response to a determination that said output current is larger than said reference signal,
measuring a peak value included in an input current flowing into each of said processors;
selecting at least one processor based on the peak value;
sending a control signal to said selected processor to reduce a clock frequency of said selected processor; and
in response to a determination that said output current is not larger than said reference signal, stopping said control signal.

10. The method of claim 9, wherein said determining is performed at a regular time interval.

11. The method of claim 9, wherein said reference signal is a triangular wave signal having a constant period.

12. The method of claim 9, wherein said selecting further includes selecting processors in each of which said peak value exceeds a predetermined threshold.

13. The method of claim 9, wherein said selecting further includes selecting processors in the order of decreasing peak values.

14. The method of claim 9, wherein said selecting further includes selecting a processor having a maximum peak value.

15. A power supply system comprising:
a power supply unit for supplying power to a plurality of processors;
a clock control determination unit for comparing an output current of said power supply unit to a reference signal to determine whether or not to send a first control signal;
a peak detection unit for detecting and outputting a peak value of an input current flowing into each of said plurality of processors;
a control object selecting part for selecting at least one of said plurality of processors based on said peak value, and for outputting a second control signal corresponding to said selected processor; and
a control signal output part for outputting a third control signal to reduce a clock frequency to said selected processor when said control signal output part receives said first control signal and said second control signal.

16. The power supply system of claim 15, wherein said control object selecting part selects a plurality of processors in each of which a peak value exceeds a predetermined threshold.

17. The power supply system of claim 15, wherein said control object selecting part selects a processor having a maximum peak value.

18. The power supply system of claim 15, wherein said control signal output part stops said third control signal when either said first control signal or said second control signal is stopped.

19. The power supply system of claim 15, wherein said control signal output part stops said third control signal after a predetermined time has elapsed.

20. The power supply system of claim 15, wherein said peak detection unit outputs a peak value of a pulse current superposed on a base current.
